(19) United States
(12) Patent Application Publication
(10) Pub. No.: US 2007/0101032 A1
(43) Pub. Date: May 3, 2007

(54) Bus arbitration circuit and bus arbitration method

(75) Inventor: Masatoshi Nara, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/583,727

(22) Filed: Oct. 20, 2006

(30) Foreign Application Priority Data
Oct. 28, 2005 (JP) 2005-313710

(51) Int. Cl. G06F 13/36; G06F 13/00

(52) U.S. Cl. 710/113; 710/110

(57) ABSTRACT

A bus arbitration circuit for arbitrating data transfers from a plurality of master devices to a slave device connected to the plurality of master devices through a bus includes an ID generation unit for arbitrating the data transfers received from the plurality of master devices and outputting identification information of a master device that output the requests in an order of an issuance of the requests or priority, and a request processor for processing the requests according to the master device identification information received from the ID generation unit. At least the request processor is provided to each of the slave device.

### BACKGROUND OF THE INVENTION

1. Field of the Invention

The present invention relates to a bus arbitration circuit and a bus arbitration method for arbitrating a data transfer request from a plurality of master devices to a slave device.

2. Description of Related Art

FIG. 3 is a view showing a conventional bus arbitration circuit. The conventional bus arbitration circuit shown in FIG. 3 includes a plurality of master devices 110 connected with a plurality of slave devices 120 through a bus module 130. In this system, in order to transfer data from the plurality of different master devices 110 to one of the slave devices 120, an arbitration circuit 131 of the bus module 130 arbitrates a transfer request in a way that it accepts a transfer request from the master device 110 after completing a transfer from the master device 110 that has started to access the slave device 120 first.

A reason for this operation is described hereinafter. In case one slave device consecutively accepts requests from a plurality of master devices, the plurality of master devices is able to transfer in a write or read data phase. In such case, an order of data transfer is not ensured, thereby resulting to execute a transfer that is output later from a master device, or disable to correctly transfer in case more than one transfers are executed at the same time.

To avoid this, the arbitration circuit 131 is provided to arbitrate so that a first data transfer is completed before accepting a next request, in case the plurality of different master devices 110 consecutively access one slave device 120. In this method, a transfer speed between master and slave devices is reduced because a period where the slave device 120 is unable to accept any request is created.

Accordingly accesses to one slave device causes to increase latency because an arbitration is performed to wait for a precedent data transfer to complete before accepting a request from next master device. This consequently prevents from improving a speed of data transfer.

To resolve this problem, a bus arbitration method for improving data transfer speed by enabling to start data transfer without waiting for data transfer to complete is disclosed in Japanese Unexamined Patent Application Publication No.5-143533 (Ito) . FIG. 4 is a view explaining the bus arbitration method disclosed by Ito.

As shown in FIG. 4, a plurality of master devices 220 is connected to a plurality of slave devices 230 via a bus. In case a data transfer request is issued, it is made to a corresponding slave device 230. The master devices 220 send an identification signal (1) indicating device information for a data transfer to an identification signal control circuit 210 as a data transfer request is issued.

The identification signal control circuit 210 is connected to the master devices 220 and the slave devices 230 through the bus for indicating a timing of a data transfer performed among the devices. The identification signal control circuit 210 stores a data transfer request (bus cycle) from the master device 220 to the slave device 230 as an identification signal (1) and notifies a data transfer timing to the bus cycle as an identification signal (2).

The slave device 230 performs a data transfer being requested through the bus in response to the data transfer request from the master device 220. The slave device 230 determines a timing of the data transfer to the bus cycle that each device is started according to the identification signal (2) sent from the identification signal control circuit 210. Information processed among the identification control circuit 210, the master devices 220, and the slave devices 230 is the identification signal (1), the identification signal (2), an address signal/transfer direction signal 243, an address strobe signal 244, an address response signal 245, a data signal 246, and a data response signal 247. This information is transmitted through the bus.

The identification signal (1) is a signal sent to the identification signal control circuit 210 when the master device 220 sends a transfer request to the slave device 230. The identification signal (1) includes information about the master device 220 which has issued the transfer request and the slave device 230 which the request is made therefor.

The identification signal (2) is a signal that the identification signal control circuit 210 indicates a timing for a data transfer. The slave device 230 performs a data transfer at the timing when this signal is indicating own slave device 230. The master device 220 and the slave device 230 synchronize with this identification signal (2) to perform a data transfer.

The address signal/transfer direction signal 243 is a signal sent from the master device 220 to the slave device 230. The address signal specifies the slave device 20 to which the signal is sent thereto. The transfer direction signal is a signal that the master device 220 indicates whether to perform a writing or reading operation to the slave device 230.

The address strobe signal 244 indicates validity/invalidity of a signal. The address strobe signal 244 indicates a timing that the slave device 230 stores the address signal/transfer direction signal 243 and the identification signal (1) sent from the master device 220.

The address response signal 245 is a signal sent from the slave device 230 to the identification signal control circuit 210 and the master device 220 when the identification signal (1) and the address signal/transfer direction signal 243 are input.

The data signal 245 is information processed between the master device 220 and the slave device 230. The data response signal 256 is a signal sent from the slave device 230 to the master device 220 and the identification signal control circuit 210. The slave device 230 sends the data signal 246 after long enough time passes for a writing or reading operation. In the reading operation, the master device 220 inputs the data signal 246 when the data response signal 247 is sent.

As described in the foregoing, the technique disclosed by Ito adds an identification signal of master and slave devices to perform a data transfer to a request signal from each master device, and performs the data transfer according to the identification signal.

In the technique disclosed by Ito, one identification signal control circuit 210 performs an arbitration of data transfer between a plurality of master and slave devices. Accordingly an identification signal identifying both of the master and slave device is required to process one request. This complicates the process for example because in case there are a large number of master and slave devices, the identification signal control circuit 210 needs to arbitrates many requests. Further, a process in adding a slave device is also complicated as the identification signal control circuit 210 needs to be replaced in such case.

### SUMMARY OF THE INVENTION

According to an aspect of the present invention, there is provided a bus arbitration circuit that arbitrates data transfer requests from a plurality of master devices to a slave device. The bus arbitration circuit includes an identification information generation unit for arbitrating the data transfer requests received from the plurality of master devices and generating master device identification information that made the requests and outputting the master device identification information, and a request processor for processing the data transfer requests according to the master device identification information received from the identification information generation unit. Further, at least the request processor is provided to each slave device.

In the present invention, a slave device can easily be added by updating only an ID generation unit because at least the request processor is provided for each slave device.

According to another aspect of the present invention, there is provided a bus arbitration method that arbitrates data transfer requests from a plurality of master devices to a slave device. The bus arbitration method generates master device identification information for identifying a master device that has issued one of the data transfer requests on a reception of the data transfer requests from the plurality of master devices. Then whether the data transfer requests are either read or write requests to the slave device is determined. After that, the bus arbitration method outputs the master device identification information to a request processor for reading provided to each of the slave device in case of a read request, and outputs the master device identification information to a request processor for writing provided to each of the slave device in case of a write request and processes the data transfer request of the read and write requests in parallel.

In the present invention, as the request processors for reading and writing are provided to each slave device, a slave device can easily be added and a read and write requests can be processed in parallel. This speeds up the process of the requests.

Accordingly the present invention provides a bus arbitration circuit and a bus arbitration method that needs a small modification in an arbitration circuit for arbitrating a data transfer between master and slave devices in case a slave device is added.

### BRIEF DESCRIPTION OF THE DRAWINGS

The above and other objects, advantages and features of the present invention will be more apparent from the following description taken in conjunction with the accompanying drawings, in which:

FIG. 1 is a block diagram showing a bus arbitration circuit according to an embodiment of the present invention;

FIG. 2 is a timing chart explaining a bus arbitration method according to an embodiment of the present invention;

FIG. 3 is a view showing a bus arbitration circuit according to a conventional technique; and

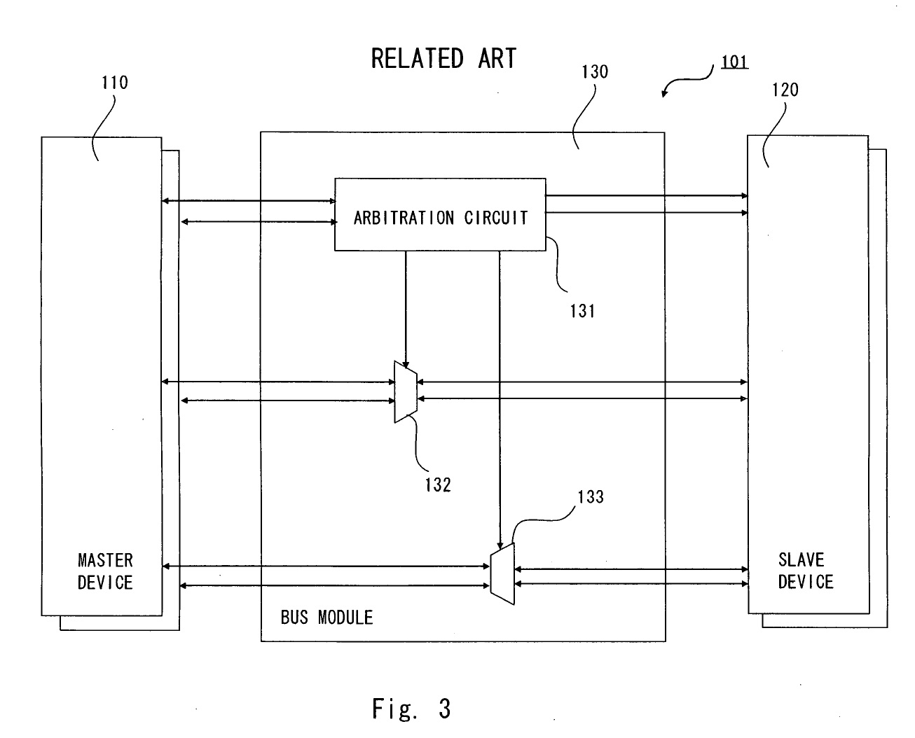

FIG. 4 is a view explaining a bus arbitration method disclosed by Ito.

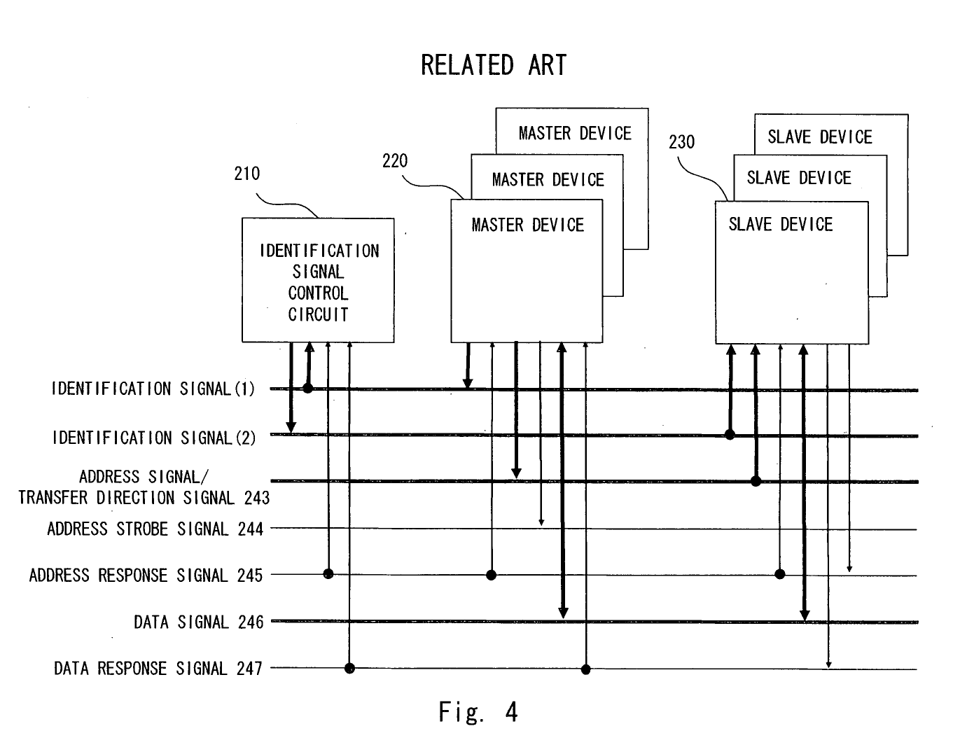

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

An embodiment of the present invention is explained hereinafter in detail with reference to the drawings. This embodiment is a bus control circuit capable of accepting a next data transfer request without waiting for a precedent data transfer to be completed in which the present invention is applied thereto.

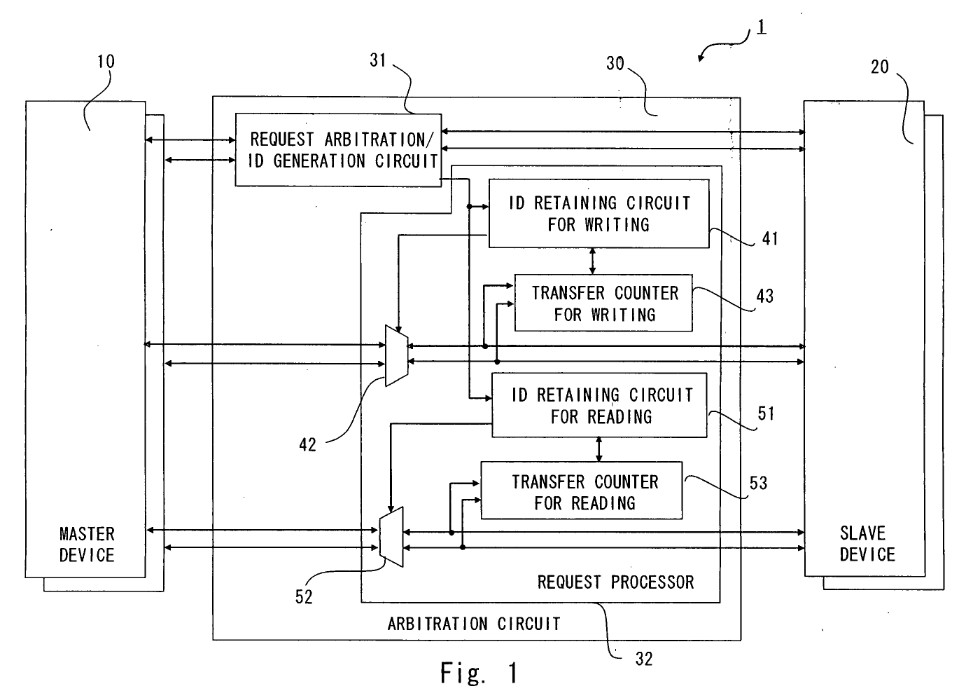

FIG. 1 is a block diagram showing a bus arbitration circuit of this embodiment. As shown in FIG. 1, a bus control system 1 is provided inside a system LSI (Large Scale Integration), for example. In an arbitration circuit 30 of this embodiment, a plurality of master devices 10 and a plurality of slave devices 20 connected therewith to form a bus control system 1. The arbitration circuit 30 arbitrates data transfer requests in a bus between the master devices 10 and the slave devices 20.

The master device 10 is for example CPU (Central Processing Unit), DSP (Digital Signal Processor), or DMA (Direct Memory Access) controller. The slave device 20 is a memory, for example

The arbitration circuit 30 includes a request arbitration/ID generation circuit 31 and a request processor 32. In this embodiment, the request processor 32 is assumed to be provided to each of the slave devices 20. Further the request arbitration/ID generation circuit 31 is assumed to be provided in common with the slave devices 20. The request arbitration/ID generation circuit 31 is provided to each of the slave devices 20 as with the request processor 32. That is, the arbitration circuit 30 can be provided to each slave device. Providing the request processor 32 to each of the slave devices 20 reduces load on each request processor 32 as well as enabling to use the request processor provided corresponding to the slave device 20 when adding another slave device 20. In such case, the slave device 20 can easily be added by changing only the request arbitration/ID generation circuit 31.

The request arbitration/ID generation circuit 31 arbitrates request phase and also outputs an ID of a master device granted with access to each of the slave devices. Specifically, in case the request arbitration/ID generation circuit 31 receives data transfer requests from the plurality of master devices 10, it distinguishes which of the slave devices 20 the requests are made therefor. Further, the request arbitration/ID generation circuit 31 distinguishes whether the request is a write or read request. Based on the determination, the request arbitration/ID generation circuit 31 sorts the data transfer request into different slave device 20, and read or write request. Then the request arbitration/ID generation circuit 31 generates the master device identification information (master device ID) for identifying the master device 10 that issued the request and outputs the information to the request processor 32 of each slave device 20 where the request is made therefor. The request arbitration/ID generation circuit 31 outputs the number of repetition of the data transfer requests (burst length) together with the master device ID.

In case the request arbitration/ID generation circuit 31 received a plurality of data transfer requests to one of the slave devices 20, it is capable of outputting the master device IDs in an order that the master devices issued the data transfer requests. Further, in case the request arbitration/ID generation circuit 31 received a plurality of data transfer requests to one of the slave devices 20 at the same time, it is capable of outputting the master device IDs in an order of priority for the master devices 10 specified in advance. Otherwise, the request arbitration/ID generation circuit 31 is also able to accept a request from one of the master devices 10 having the highest priority and outputs its master device ID. The master device IDs and the number of repetition are output to the request processor 32 in an order of the issuance or priority. In this case, the requests are output to either of an ID retaining circuit for writing 41 or an ID retaining circuit for reading 51 in the request processor 32 of each slave device 20 depending on a type of the request, which is write or read request. Differentiating the requests into a write or a read request enables to efficiently use buses for reading and writing as well as speeding up a process of the request.

As described in the foregoing, the requests from the master devices 10 can be sorted to request processor 32 of a corresponding slave device 20 by the request arbitration/ID generation circuit 31. The request processor 32 is a circuit for processing the requests according to the master device ID and the number of repetition received from the request arbitration/ID generation circuit 31. The request processor 32 is comprised of a request processor for writing that processes a write request and a request processor for reading that processes a read request from the master devices 10 to the slave devices 20.

The request processor for writing includes the ID retaining circuit for writing 41, a write phase signal arbitration circuit 42, and a transfer counter for writing 43. The request processor for reading is configured in the same way, having an ID retaining circuit for reading 51, a read phase signal arbitration circuit 52, and a transfer counter for reading 53. The master device ID and the number of repetition assigned by the request arbitration ID generation circuit 31 to each of the slave devices 20 are assigned either to the ID retaining circuit for writing 41 or the ID retaining circuit for reading 51 whether the request is a read or write request.

The ID retaining circuit 41 for writing functions as a request retaining unit for retaining the master device ID and the number of counts. Furthermore, the ID retaining circuit for writing 41 controls the write phase signal arbitration circuit 42 according to the master device ID in an order of the requests being retained. The write phase signal arbitration circuit 42 functions as a selection unit for connecting a particular device indicated by the master device ID among the plurality of master devices 10 with the slave device 20 according to the master device ID from the ID retaining circuit for writing 41.

The transfer counter for writing 43 is connected between the slave device 20 and the write phase signal arbitration circuit 42. The transfer counter for writing 43 functions as a transfer monitoring unit that notifies a completion of a request to the ID retaining circuit for writing 41 according to a completion signal (ACK) output by the slave device 20 after processing the request.

Then the circuits of the request processor 32 are explained hereinafter in detail. As described in the foregoing, the request processor 32 is provided to each of the slave devices. Further, the request assigned to each of the slave devices by the request arbitration ID generation circuit 31 is assigned to the ID retaining circuit for writing 41 or the ID retaining circuit for reading 51 depending on whether the request is a write or read request.

The ID retaining circuit for writing 41 retains a write request among the data transfer requests assigned by the request arbitration ID generation circuit 31. At this time, the master device ID for identifying a master device that has issued the write request and the number of transfer for write data is retained for each request. Then the master device ID is output to the write phase signal arbitration circuit 42 in an order of the retention. After a process of a request is completed, a master. ID of a next request is output.

Similarly the ID retaining circuit for reading 51 retains a write request among the data transfer requests assigned by the request arbitration ID generation circuit 31. Then the ID retaining circuit for reading 51 outputs the master device ID in an order of the retention to the read phase signal arbitration circuit 52.

After receiving the master device ID, the write phase signal arbitration circuit 42 decodes the master device ID and connects the master device 10 that issued the request with the slave device 20. Similarly the read phase signal arbitration circuit 52 connects the master device 10 that issued the request with the slave device 20 according to the master device ID.

The transfer counter for writing 43 receives a transfer completion notification indicating of a completion of a write data transfer and notifies of the completion to the ID retaining circuit for writing 41. The retaining circuit for writing 41 clears current request in response to the notification and moves to process a next request. For a request that writes the same data repeatedly, the transfer completion notification is received for each data transfer, and counts up the notification to the number of completion, so as to notify the completion of the request to the ID retaining circuit for writing 41. The transfer counter for reading 53 operates in the similar manner.

In case the slave device 20 repeatedly transfers and a transfer completion notification is output only when all data transfer is completed not for every transfer completion, the transfer counter for writing 43 and the transfer counter for reading 53 detects the transfer completion notification so as to notify to the ID retaining circuit for writing 41 and the ID retaining circuit for reading 51. The transfer counter for writing 43 and the transfer counter for reading 53 may be provided inside the ID retaining circuit for writing 41 and the ID retaining circuit for reading respectively. Further, the transfer counter for writing 43 and the transfer counter for reading 53 need not to be provided but the ID retaining circuit for writing 41 and the ID retaining circuit for reading 51 may directly receive the data transfer completion notification from the slave device.

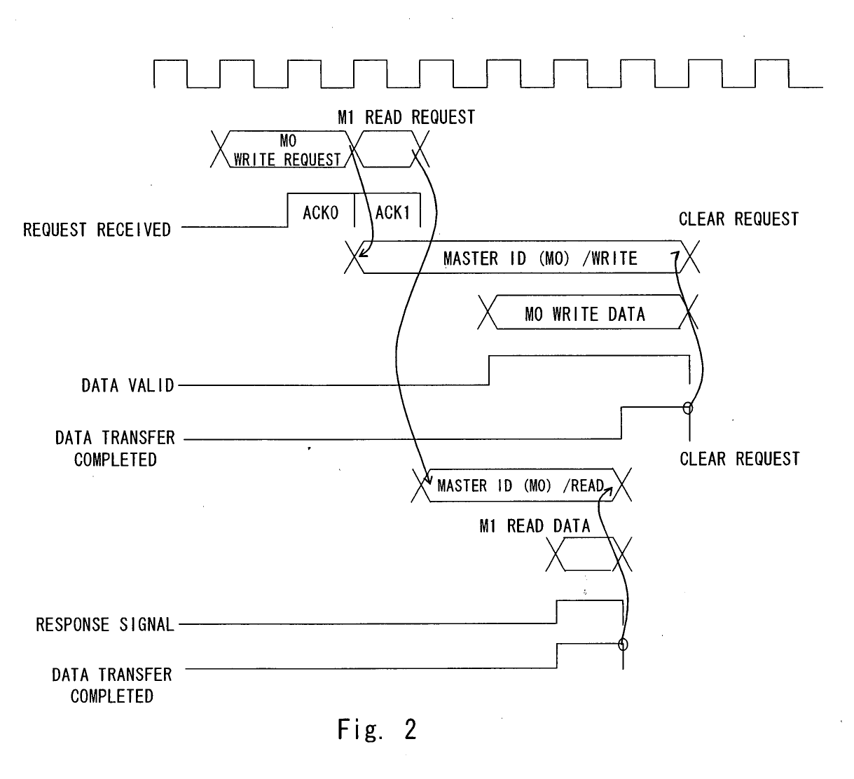

An operation of the bus arbitration circuit of this embodiment is described hereinafter in detail. In this embodiment, a case where two master devices 10 (hereinafter referred to as master devices M0 and M1) consecutively issue write transfer request (write request) and a read transfer request (read request) to a slave device 20. FIG. 2 is a timing chart explaining an operation of a bus arbitration circuit 1.

Firstly the master device M0 issues a write request to the slave device 20. The write request is transferred to the slave device 20 directly or through the request arbitration ID generation circuit 31. The write request includes an address of write data and so on. The slave device 20 that has received the write requests outputs a request received (ack0) to the request arbitration ID generation circuit 31. Similarly the master device M1 issues a read request to the slave device 20. The read request is transferred to the slave device 20 directly or through the request arbitration ID generation circuit 31. The read request includes an address of read data and soon. Then the slave device that has received the read request outputs a request received (ack1) to the request arbitration ID generation circuit 31.

In this example, the requests are made for the same slave device 20, and are a read and write requests, which are processed in different buses (read and write buses) and issued sequentially. Thus the request arbitration ID generation circuit 31 recognizes the requests as processable and passes the request received (ack0 and ack1) from the slave device 20 to the master device 10. The requests from the master devices M0 and M1 are received in this way.

In case a write request (request of the same kind) is issued from a plurality of master devices 10 to the same slave device 10, the request arbitration ID generation circuit 31 arbitrates the requests by returning request received of the requests from the master device 10 having high priority among the request received passed from the slave device 20.

The request arbitration ID generation circuit 31 sequentially processes the requests being received. In this example, the request arbitration ID generation circuit 31 outputs a master device ID indicating the master device M0 and the number of write data repetition to the ID retaining circuit for writing 41. The ID retaining circuit for writing 41 outputs the received master device ID to the write phase signal arbitration circuit 42 (the master ID shown in FIG. 2 (M0)). The write phase signal arbitration circuit 42 connects the master device M0 with the slave device 20 according to the master device ID so that a signal from the master device M0 can be transferred to the slave device 20. The master device M0 and the slave device 20 are connected while the master device ID is being output.

The request arbitration ID generation circuit 31 outputs a master device ID indicating the master device M1 and the number of repetition from the read request of the master device M1 to the ID retaining circuit for reading 51. The ID retaining circuit for reading 51 outputs the received master device ID to the read phase signal arbitration circuit 52 (the master ID shown in FIG. 2 (M1)). The read phase signal arbitration circuit 52 connects the master device M1 with the slave device 20 according to the master device ID so that a signal from the master device M1 can be transferred to the slave device 20. The master device M1 and the slave device 20 are connected while the master device ID is being output. As the request from the master device M1 is a read request, the write request from the abovementioned master device M0 can be processed in parallel with the read request.

After the master device M0 and the slave device 20 are connected, the master device M0 outputs the write data to the slave device 20 and a signal (data valid) indicating that the write data is valid. At this time the transfer counter for writing 43 counts the number of data transfer completion signals in the write data phase of the slave device 20. When the transfer counter for writing 43 received the transfer completion signals for the number of repetition retrained in the ID retaining circuit for writing 41, it notifies the completion to the ID retaining circuit for writing 41. Or the transfer counter for writing 43 receives a data transfer completion signal output on a completion of a data transfer from the slave device, and notifies the completion to the ID retaining circuit for writing 41.

The retaining circuit for writing 41 clears the requests (master device IDs and the number of repetition) being retained in response to this notification and ends outputting the master device ID. This ends a connection between the master device M0 and the slave device 20 by the write phase signal arbitration circuit 42 and ends a command process. In case the slave device 20 does not output the data transfer completion signal, the transfer counter for writing 43 needs not to be provided and the ID retaining circuit for writing 41 may ends the process after waiting for enough time to complete the data transfer after outputting the master device ID.

On the other hand, in case the master device M1 and the slave device 20 are connected, the slave device 20 transfer a response signal indicating that the read data to be transferred is valid and the read data being read out to the master device M1.

The transfer counter for reading 53 counts the number of data transfer completion signals in the read data phase of the slave device 20. When the transfer counter for writing 43 received the transfer completion signals for the number of repetition retrained in the ID retaining circuit for reading 51, it notifies the completion to the ID retaining circuit for reading 51. Or the transfer counter for writing 43 receives a data transfer completion signal output on a completion of a data transfer from the slave device, and notifies the completion to the ID retaining circuit for reading 51.

The ID retaining circuit for reading 51 clears the requests (the master device ID and the number of repetition) being retained in response to the notification and ends outputting the master device ID. This ends a connection between the master device M1 and the slave device 20 by the read phase signal arbitration circuit 52 and ends a command process. As with the writing, the ID retaining circuit for reading 51 may ends the process after waiting for enough time to complete the data transfer after outputting the master device ID.

In this embodiment, by providing the request processor 32 for processing requests from the master devices 10 to each of the slave devices 20, a new slave device 20 can easily be added. Further, by storing the master IDs to perform data transfers in the request processor, a plurality of requests can be received and the request processor 32 is able to process read and write requests separately. This reduces latency more than a conventional technique, thereby speeding up the data transfers.

Accordingly by providing the request processor 32 to each of the slave devices 20, only the request arbitration ID generation circuit 31 needs to be changed, not the whole arbitration circuit 30, in order to add a slave device.

Further, in case requests are issued from a plurality of different master devices 10 to the same slave device 20, the request arbitration ID generation circuit 31 sorts the requests to each of the slave devices 20 as master device IDs that issued the requests. At this time the request processor 32 provided to each of the slave devices sequentially sorts the master device IDs into read or write requests by the ID retaining circuit for writing 41 and the ID retaining circuit for reading 51.

By this operation, in case the plurality of master devices 10 issued requests to the same slave device 20 at the same time, a next request can be issued without waiting for a completion of a first data transfer. Further, a write and read requests can be executed at the same time because the requests are processed separately, thereby speeding up the process of the requests.

The present invention is not limited to the above embodiment and it may be modified and changed without departing from the scope and sprit of the present invention. For example in this embodiment, the request arbitration ID generation circuit 31 is provided in common with the slave devices. However it may be provided to each slave device as with the request processor 32. In such case, the request arbitration ID generation circuit can determine whether a request received from a master device is issued for the own slave device. This facilitates an addition of the slave device 20.

Further in the above embodiment, the ID retaining circuit for writing 41 and the ID retaining circuit for reading 51 are to retain a master device ID and a burst length of transfer data. However the circuit may be configured to retain only the master device. To determine whether a data transfer by a request is completed or not, a transfer completion notification output from a slave device at a completion of the data transfer can be used. The write phase signal arbitration circuit 42 and the read phase signal arbitration circuit 52 can be controlled based on this notification.

It is apparent that the present invention is not limited to the above embodiment and it may be modified and changed without departing from the scope and spirit of the invention.

What is claimed is:

1. A bus arbitration circuit comprising:
an identification information generation unit for arbitrating data transfer requests from a plurality of master devices to a slave device and generating master device identification information that made the requests and outputting the master device identification information; and
a request processor for processing the data transfer request according to the master device identification information received from the identification information generation unit,
wherein at least the request processor is provided to each of the slave device.

2. The bus arbitration circuit according to claim 1, wherein the request processor comprises:
a request retaining unit for retaining the master device identification information; and
a selection unit for connecting the slave device with one of the plurality of master devices,
wherein the request retaining unit controls a connection of the selection unit according to the master device identification information.

3. The bus arbitration circuit according to claim 1, wherein the identification information generation unit is provided to each of the slave device, and
the identification information generation unit selects requests to own slave device among the data transfer requests received from the plurality of master devices and outputs master device identification information of master devices that issued the selected requests.

4. The bus arbitration circuit according to claim 1, wherein the request processor is comprised of a request processor for writing and a request processor for reading; and
the request processor for writing and the request processor for reading each includes the request retaining unit and the selection unit.

5. The bus arbitration circuit according to claim 1, wherein in case the identification information generation unit receives more than one of the data transfer requests from one of the plurality of master devices, the identification information generation unit outputs the master device identification information to the master device in an order of the reception.

6. The bus arbitration circuit according to claim 1, wherein in case the identification information generation unit receives more than one of the data transfer requests to one of the plurality of master devices, the identification information generation unit outputs the master device identification information to the master device in an order of a priority of the master device that has issued the data transfer requests.

7. The bus arbitration circuit according to claim 1, wherein in case the identification information generation unit receives more than one of the data transfer requests to one of the plurality of master devices, the identification information generation unit outputs the master device identification information of a master device having the highest priority to one of the plurality of master devices.

8. The bus arbitration circuit according to claim 1, wherein the request processor further comprises a transfer monitoring unit connected between the slave device and the plurality of master devices, and
the transfer monitoring unit detects a transfer completion between the slave device and the master devices and notifies the transfer completion of the data transfer requests to the request retaining unit.

9. The bus arbitration circuit according to claim 8, wherein the identification information generation unit outputs the number of data transfer repetition with the master device identification information on a reception of the data transfer requests; and
the transfer monitoring unit counts the number of data transfers according to the number of data transfer repetition and notifies a completion of the data transfer requests based on a result of the count.

10. The bus arbitration circuit according to claim 2, wherein the identification information generation unit is provided to each of the slave device, and
the identification information generation unit selects requests to own slave device among the data transfer requests received from the plurality of master devices and outputs master device identification information of master devices that issued the selected requests.

11. The bus arbitration circuit according to claim 2, wherein the request processor is comprised of a request processor for writing and a request processor for reading; and
the request processor for writing and the request processor for reading each includes the request retaining unit and the selection unit.

12. The bus arbitration circuit according to claim 2, wherein in case the identification information generation unit receives more than one of the data transfer requests from one of the plurality of master devices, the identification information generation unit outputs the master device identification information to the master device in an order of the reception.

13. The bus arbitration circuit according to claim 2, wherein in case the identification information generation unit receives more than one of the data transfer requests to one of the plurality of master devices, the identification information generation unit outputs the master device identification information to the master device in an order of a priority of the master device that has issued the data transfer requests.

14. The bus arbitration circuit according to claim 2, wherein in case the identification information generation unit receives more than one of the data transfer requests to one of the plurality of master devices, the identification information generation unit outputs the master device identification information of a master device having the highest priority to one of the plurality of master devices.

15. The bus arbitration circuit according to claim 2, wherein the request processor further comprises a transfer monitoring unit connected between the slave device and the plurality of master devices, and
the transfer monitoring unit detects a transfer completion between the slave device and the master devices and notifies the transfer completion of the data transfer requests to the request retaining unit.

16. The bus arbitration circuit according to claim 3, wherein the request processor is comprised of a request processor for writing and a request processor for reading; and
the request processor for writing and the request processor for reading each includes the request retaining unit and the selection unit.

17. The bus arbitration circuit according to claim 3, wherein in case the identification information generation unit receives more than one of the data transfer requests from one of the plurality of master devices, the identification information generation unit outputs the master device identification information to the master device in an order of the reception.

18. The bus arbitration circuit according to claim 3, wherein in case the identification information generation unit receives more than one of the data transfer requests to one of the plurality of master devices, the identification information generation unit outputs the master device identification information to the master device in an order of a priority of the master device that has issued the data transfer requests.

19. The bus arbitration circuit according to claim 3, wherein in case the identification information generation unit receives more than one of the data transfer requests to one of the plurality of master devices, the identification information generation unit outputs the master device identification information of a master device having the highest priority to one of the plurality of master devices.

20. A bus arbitration method for arbitrating data transfer requests from a plurality of master devices to a slave device comprising:
generating master device identification information for identifying a master device that has issued one of the data transfer requests on a reception of the data transfer requests from the plurality of master devices;
determining whether the data transfer requests are either read or write requests to the slave device;
outputting the master device identification information to a request processor for reading provided to each of the slave device in case of a read request, and outputting the master device identification information to a request processor for writing provided to each of the slave device in case of a write request; and
processing the data transfer request of the read and write requests in parallel.
